(19) United States
(12) Patent Application Publication
(10) Pub. No.: US 2015/0317305 A1
(43) Pub. Date: Nov. 5, 2015

(54) Language Translation Assembly

(71) Applicant: Gilbert R. Ortiz, Montclair, CA (US)

(72) Inventor: Gilbert R. Ortiz, Montclair, CA (US)

(21) Appl. No.: 14/267,081

(22) Filed: May 1, 2014

(51) Int. Cl. G06F 17/28

(52) U.S. Cl. CPC G06F 17/289

(57) ABSTRACT

A language translation assembly for translating a language of a speaker into language of a listener includes a housing carried by a user. A processor is coupled to the housing. A transceiver is coupled to the housing and the processor. The transceiver is in communication with a signal repeater. A microphone is coupled to the housing and the processor. A speaker is coupled to the housing and the processor. A camera is coupled to the housing. The camera records an environment proximate the housing and the processor. A light emitter is coupled to the housing and the processor. A primary actuator is coupled to the housing and the processor. The primary actuator selectively actuates and de-actuates the processor. A secondary actuator is coupled to the housing and the processor. The secondary actuator selectively actuates and de-actuates the transceiver.

### BACKGROUND OF THE DISCLOSURE

### Field of the Disclosure

The disclosure relates to language translation devices and more particularly pertains to a new language translation device for translating a language of a speaker into language of a listener.

### SUMMARY OF THE DISCLOSURE

An embodiment of the disclosure meets the needs presented above by generally comprising a housing carried by a user. A processor is coupled to the housing. A transceiver is coupled to the housing. The transceiver is operationally coupled to the processor. The transceiver is in communication with a signal repeater. A microphone is coupled to the housing. The microphone detects audible sound. The microphone is operationally coupled to the processor. A speaker is coupled to the housing so the speaker emits an audible sound. The speaker is operationally coupled to the processor. A camera is coupled to the housing. The camera records an environment proximate the housing. The camera is operationally coupled to the processor. A light emitter is coupled to the housing. The light emitter is operationally coupled to the processor. A primary actuator is coupled to the housing. The primary actuator is operationally coupled to the processor. The primary actuator selectively actuates and de-actuates the processor. A secondary actuator is coupled to the housing. The secondary actuator is operationally coupled to the processor. the secondary actuator selectively actuates and de-actuates the transceiver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a language translation assembly according to an embodiment of the disclosure.

FIG. 2 is a bottom view of an embodiment of the disclosure.

FIG. 3 is a front view of an embodiment of the disclosure.

FIG. 4 is a back view of an embodiment of the disclosure.

FIG. 5 is a schematic view of an embodiment of the disclosure.

### DESCRIPTION OF THE PREFERRED EMBODIMENT

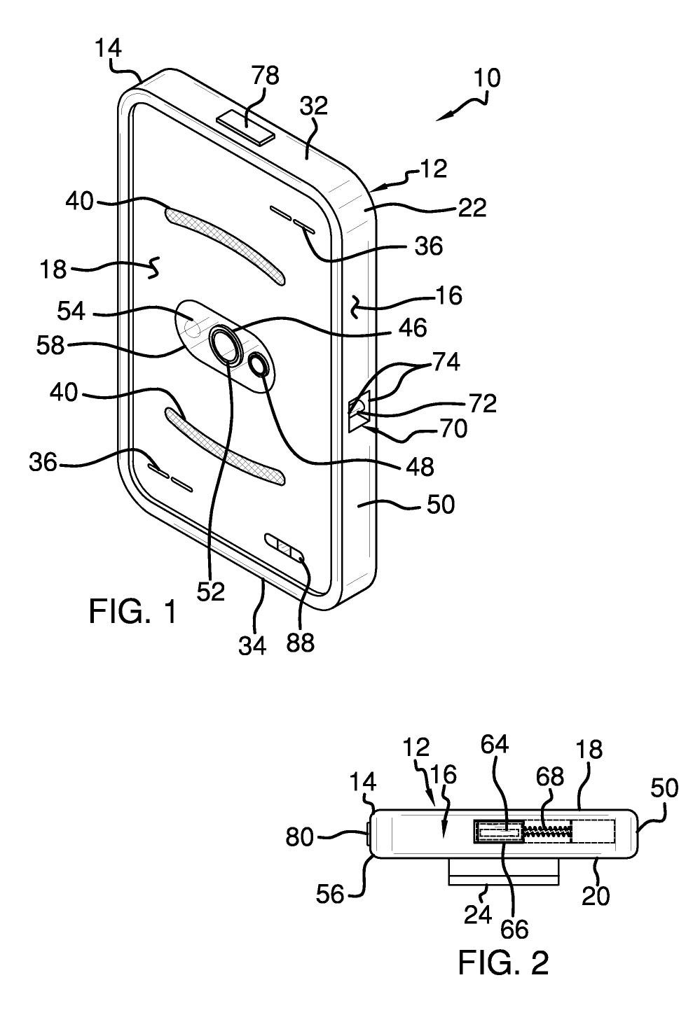

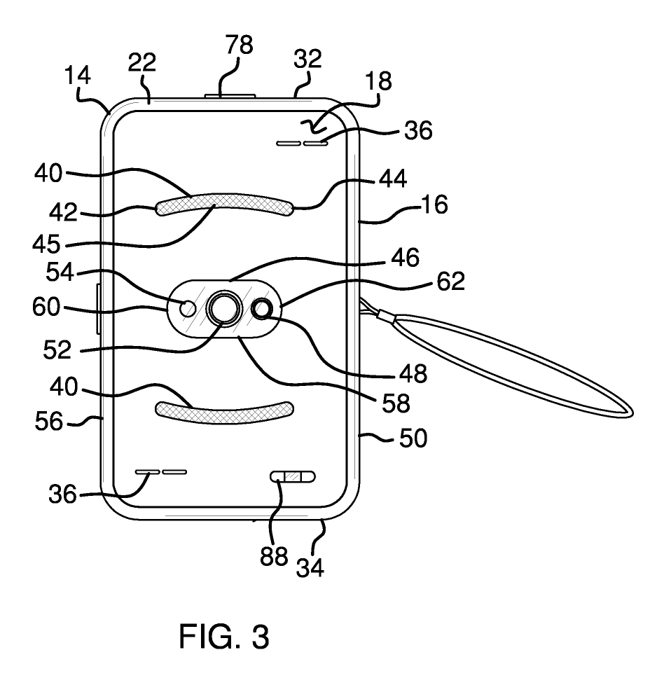

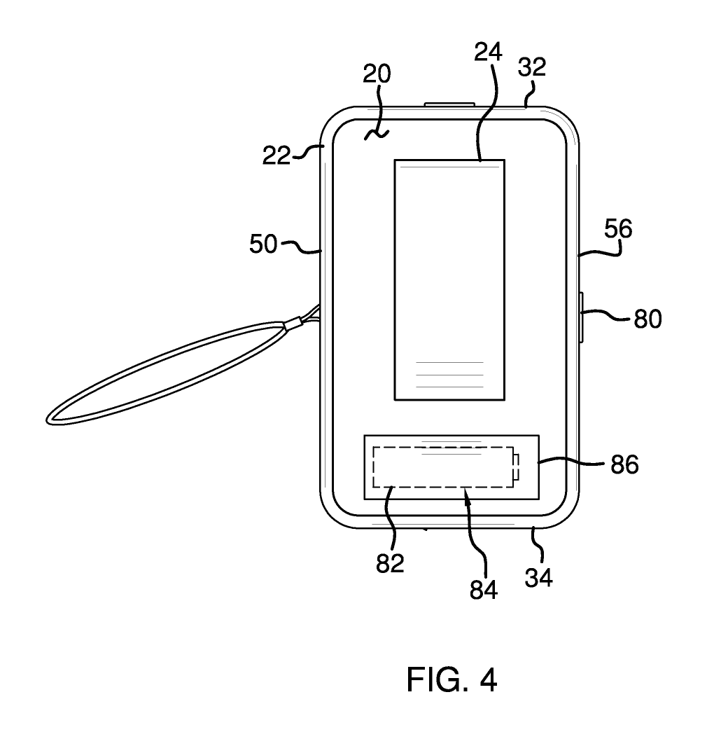

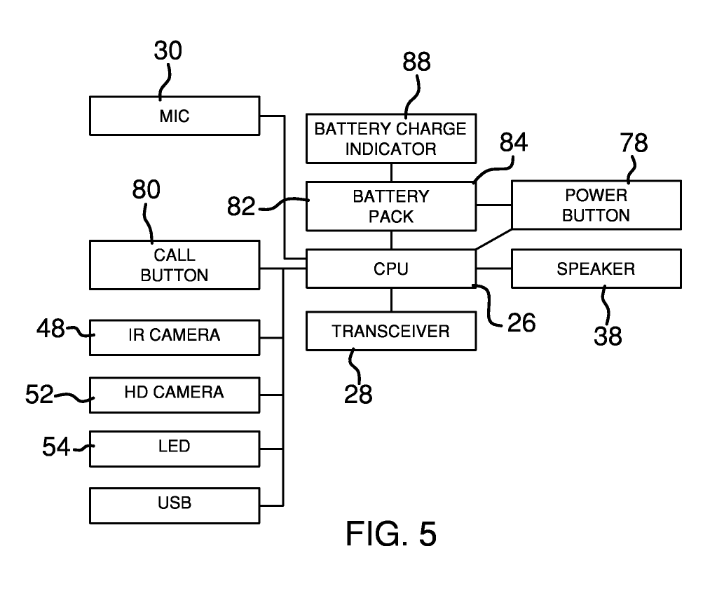

With reference now to the drawings, and in particular to FIGS. 1 through 5 thereof, a new language translation device embodying the principles and concepts of an embodiment of the disclosure and generally designated by the reference numeral 10 will be described.

As best illustrated in FIGS. 1 through 5, the language translation assembly 10 generally comprises a housing 12 carried by a user. The user may be a law enforcement officer. An outer wall 14 of the housing 12 has an exterior surface 16 extending between a front surface 18 and a back surface 20 of the outer wall 14 of the housing 12. The housing 12 has a rectangular parallelepiped shape that may have a height between 7 cm and 10 cm, and width between 5 cm and 7 cm and a depth between 2 cm and 4 cm.

A sheath 22 is coupled to the housing 12. The sheath 22 completely covers the outer wall 14 of the housing 12. Moreover, the sheath 22 may be comprised of a resiliently compressible and fluid impermeable material. The sheath 22 protects the housing 12 from impact shock and from fluid damage.

A retainer 24 is rotatably coupled to the back surface 20 of the outer wall 14 of the housing 12. The retainer 24 removably engages an article of the user's clothing so the housing 12 is retained on the user's clothing. The housing 12 is rotatable when the retainer 24 engages the article of the user's clothing. Additionally, the housing 12 is positioned on the user's clothing so the housing 12 faces forwardly on the user. The retainer 24 may be an alligator clip of any conventional design. Alternatively, the retainer 24 may comprised a magnet. The retainer 24 selectively magnetically engages a metallic element of the article of the user's clothing.

A processor 26 is coupled to the housing 12. The processor 26 may be an electronic processor of any conventional design. A transceiver 28 is coupled to the housing 12. The transceiver 28 is electrically coupled to the processor 26. Moreover, the transceiver 28 may be an RF transceiver of any conventional design.

The transceiver 28 may utilize a CDMA wireless network access signal that may have a frequency between 800 MHz and 1900 MHz. The transceiver 28 is in electromagnetic communication with a signal repeater. The signal repeater may be a satellite or a cellular phone tower. Additionally, the transceiver 28 is in electromagnetic communication with a remote location.

A microphone 30 is coupled to the front surface 18 of the outer wall 14 of the housing 12. The microphone 30 detects audible sound. The microphone 30 is electrically coupled to the processor 26. Moreover, the microphone 30 may be a voice actuated condenser microphone of any conventional design. The microphone 30 is one of a pair of the microphones 30 each positioned proximate an associated one of a top side 32 and a bottom side 34 on the exterior surface 16 of the outer wall 14 of the housing 12. The housing 12 has a pair of microphone openings 36 extending through the front surface 18 of the outer wall 14 of the housing 12. Each of the pair of microphones 32 is positioned behind an associated one of the pair of microphone openings 36.

A speaker 38 is coupled to the front surface 18 of the outer wall 14 of the housing 12. The speaker 38 emits an audible sound. The speaker 38 is electrically coupled to the processor 26. The speaker 38 is one of a pair of the speakers 38 each positioned proximate an associated one of the top 32 and bottom 34 sides of the exterior surface 16 of the outer wall 14 of the housing 12. Each of the pair of speakers 38 may be audio speakers of any conventional design.

The housing 12 has a pair of speaker opening 40 extends through the front surface 18 of the outer wall 14 of the housing 12. Each of the pair of speaker openings 40 has a first end 42 and a second end 44. The pair of speaker openings 40 is each elongated. Additionally, the each of the pair of speaker openings 40 is curved so the pair of speaker openings 40 each has a banana shape. Each of the pair of speakers 40 is positioned behind an associated one of the pair of speaker openings 40. A mesh 45 completely covers each of the pair of speaker openings 40.

A camera 46 is coupled to the front surface 18 of the outer wall 14 of the housing 12. The camera 46 is centrally positioned on the front surface 18 of the outer wall 14 of the housing 12 so the camera 46 may record an environment proximate the housing 12. Additionally, the camera 46 is electrically coupled to the processor 26. The camera 46 may be a video camera of any conventional design.

The camera 46 is one of a pair of the cameras 46. A second one of the pair of cameras 48 is spaced toward a first lateral side 50 of the exterior surface 16 of the outer wall 14 of the housing 12. The second camera 48 may be an infrared camera of any conventional design. A first one of the pair of cameras 52 may be an HD video camera of any conventional design.

A light emitter 54 is coupled to the front surface 18 of the outer wall 14 of the housing 12. The light emitter 54 is centrally positioned on the front surface 18 of the outer wall 14 of the housing 12. Moreover, the light emitter 54 is spaced away from the first camera 52 toward a second lateral side 56 of the exterior surface 16 of the outer wall 14 of the housing 12. The light emitter 54 is electrically coupled to the processor 26. The light emitter 54 may be an LED of any conventional design.

A window 58 is coupled to the front surface 18 of the outer wall 14 of the housing 12. The window 58 has a primary end 60 and a secondary end 62. Each of the primary 60 and secondary 62 ends of the window 58 are rounded. The window 58 is elongated between the primary 60 and secondary 62 ends. Moreover, the window 58 is positioned over the light emitter 54 and the first 52 and second 48 cameras. The window 58 protects the light emitter 54 and the first 52 and second 48 cameras.

A data port 64 is coupled to and extend upwardly from the bottom side 34 of the exterior surface 16 of the outer wall 14 of the housing 12. The data port 64 is electrically coupled to the processor 26. The data port 64 removably receives a data cable so the data cable is electrically coupled to the processor 26. Moreover, the data port 64 may be a USB data port of any conventional design.

A cover 66 is slidably coupled to the bottom side 34 of the exterior surface 16 of the outer wall 14 of the housing 12. A spring biasing member 68 is coupled to the housing 12 and engages the cover 66. The spring biasing member 68 biases the cover 66 in a closed position. The cover 66 covers the data port 64 when the cover 66 is biased in the closed position.

The housing 12 has a lanyard well 70 extending inwardy from the first lateral side 50 of the exterior surface 16 of the outer wall 14 of the housing 12. A rod 72 extends between each of a pair of lateral bounding surfaces 74 of the lanyard well 70. A lanyard 76 is removably coupled to the rod 72. The lanyard 76 is removably coupled to the user so the housing 12 is retained on the user.

A primary actuator 78 is movably coupled to the top side 32 of the exterior surface 16 of the outer wall 14 of the housing 12. The primary actuator 78 is electrically coupled to the processor 26 so the primary actuator 78 selectively actuates and de-actuates the processor 26. The user actuates the primary actuator 78 to actuate the processor 26. A secondary actuator 80 is movably coupled to the second lateral side 56 of the exterior surface 16 of the outer wall 14 of the housing 12. The secondary actuator 80 is electrically coupled to the processor 26 so the secondary actuator 80 selectively actuates and de-actuates the transceiver 28. The user actuates the secondary actuator 80 to place the transceiver 28 in electromagnetic communication with the remote location.

A power supply 82 is coupled to the housing 12. The power supply 82 is electrically coupled to the primary actuator 78. Moreover, the power supply 82 comprises at least one battery 84. A battery cover 86 is removably coupled to the back surface 20 of the outer wall 14 of the housing 12. The battery 84 is positioned beneath the battery cover 86.

A charge indicator 88 is coupled to the front surface 18 of the outer wall 14 of the housing 12. The charge indicator 88 is positioned proximate an intersection of the bottom side 34 and the first lateral side 50 of the exterior surface 16 of the outer wall 14 of the housing 12. Additionally, the charge indicator 88 is electrically coupled to the power supply 82. The charge indicator 88 indicates a charge level of the power supply 82.

In use, the user actuates the secondary actuator 80 when the user encounters an individual who does not speak the native language of the user. The transceiver 28 is placed into electromagnetic communication with the remote location. A translating individual receives the spoken word of the individual from the microphone 30. The translating individual translates the spoken words of the individual into the native language of the user. The translated spoken words of the individual are emitted through the pair of speakers 38 so the user understands the spoken words of the individual.

The user speaks a reply or command to the individual. The microphone 30 sends the user's spoken words to the translating individual. The translating individual translates the spoken words of the user into the language of the individual. The translated spoken words of the user are emitted through the pair of speakers 38 so the individual understands the spoken words of the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A language translation assembly configured to translate a language of a speaker into language of a listener, said assembly comprising:
a housing;
a processor coupled to said housing;
a transceiver coupled to said housing, said transceiver being operationally coupled to said processor, said transceiver being in communication with a signal repeater;
a microphone coupled to said housing such that said microphone detects audible sound, said microphone being operationally coupled to said processor;
a speaker coupled to said housing such that said speaker emits an audible sound, said speaker being operationally coupled to said processor;
a camera coupled to said housing such that an environment proximate said housing is recordable, said camera being operationally coupled to said processor;
a light emitter coupled to said housing, said light emitter being operationally coupled to said processor;
a primary actuator coupled to said housing, said primary actuator being operationally coupled to said processor such that said primary actuator selectively actuates and de-actuates said processor; and
a secondary actuator coupled to said housing, said secondary actuator being operationally coupled to said processor such that said secondary actuator selectively actuates and de-actuates said transceiver.

2. The assembly according to claim 1, wherein an outer wall of said housing having an exterior surface extending between a front surface and a back surface of said outer wall of said housing such that said housing has a rectangular parallelepiped shape.

3. The assembly according to claim 1, further comprising said transceiver being electrically coupled to said processor, said transceiver being in electromagnetic communication with the signal repeater.

4. The assembly according to claim 1, further comprising said microphone being coupled to a front surface of an outer wall of said housing, said microphone being electrically coupled to said processor.

5. The assembly according to claim 4, wherein said microphone being one of a pair of said microphones each positioned proximate an associated one of a top side and a bottom side on an exterior surface of said outer wall of said housing.

6. The assembly according to claim 1, further comprising said camera being coupled to a front surface of an outer wall of said housing such that said camera is centrally positioned on said front surface of said outer wall of said housing, said camera being electrically coupled to said processor.

7. The assembly according to claim 6, further comprising said camera being one of a pair of said cameras, a second one of said pair of cameras being spaced toward a first lateral side of an exterior surface of said outer wall of said housing.

8. The assembly according to claim 1, further comprising said light emitter being coupled to a front surface of an outer wall of said housing such that said light emitter is centrally positioned on said front surface of said outer wall of said housing, said light emitter being spaced away from a first one of a pair of said cameras toward a second lateral side of an exterior surface of said outer wall of said housing, said light emitter being electrically coupled to said processor.

9. The assembly according to claim 1, further comprising said speaker being coupled to a front surface of an outer wall of said housing, said speaker being electrically coupled to said processor.

10. The assembly according to claim 9, further comprising said speaker being one of a pair of said speakers each positioned proximate an associated one of a top side and a bottom side of an exterior surface of said outer wall of said housing.

11. The assembly according to claim 1, further comprising said primary actuator being movably coupled to a top side of an exterior surface of an outer wall of said housing, said primary actuator being electrically coupled to said processor.

12. The assembly according to claim 1, further comprising said secondary actuator being movably coupled to a second lateral side of an exterior surface of an outer wall of said housing, said secondary actuator being electrically coupled to said processor.

13. The assembly according to claim 1, further comprising a power supply coupled to said housing.

14. The assembly according to claim 13, further comprising said power supply being electrically coupled to said primary actuator.

15. The assembly according to claim 14, further comprising said power supply comprising at least one battery.

16. A language translation assembly configured to translate a language of a speaker into language of a listener, said assembly comprising:
a housing, an outer wall of said housing having an exterior surface extending between a front surface and a back surface of said outer wall of said housing such that said housing has a rectangular parallelepiped shape;
a processor coupled to said housing;
a transceiver coupled to said housing, said transceiver being electrically coupled to said processor, said transceiver being in electromagnetic communication with a signal repeater;
a microphone coupled to said front surface of said outer wall of said housing such that said microphone detects audible sound, said microphone being electrically coupled to said processor;
said microphone being one of a pair of said microphones each positioned proximate an associated one of a top side and a bottom side on said exterior surface of said outer wall of said housing;
a speaker coupled to said front surface of said outer wall of said housing such that said speaker emits an audible sound, said speaker being electrically coupled to said processor;
said speaker being one of a pair of said speakers each positioned proximate an associated one of said top side and a bottom side of said exterior surface of said outer wall of said housing;
a camera coupled to said front surface of said outer wall of said housing such that said camera is centrally positioned on said front surface of said outer wall of said housing, said camera recording an environment proximate the housing, said camera being electrically coupled to said processor;
said camera being one of a pair of said cameras, a second one of said pair of cameras being spaced toward a first lateral side of said exterior surface of said outer wall of said housing;
a light emitter coupled to said front surface of said outer wall of said housing such that said light emitter is centrally positioned on said front surface of said outer wall of said housing, said light emitter being spaced away from a first one of a pair of said cameras toward a second lateral side of said exterior surface of said outer wall of said housing, said light emitter being electrically coupled to said processor;
a primary actuator movably coupled to a top side of said exterior surface of said outer wall of said housing, said primary actuator being electrically coupled to said processor such that said primary actuator selectively actuates and de-actuates said processor;
a secondary actuator movably coupled to said second lateral side of said exterior surface of said outer wall of said housing, said secondary actuator being electrically coupled to said processor such that said secondary actuator selectively actuates and de-actuates said transceiver; and
a power supply coupled to said housing, said power supply being electrically coupled to said primary actuator, said power supply comprising at least one battery.
